(19) United States
(12) Patent Application Publication
(10) Pub. No.: US 2015/0168704 A1
(43) Pub. Date: Jun. 18, 2015

(54) PHASE DIFFERENCE OBSERVATION APPARATUS

(71) Applicant: CANON KABUSHIKI KAISHA, Tokyo (JP)

(72) Inventor: Kazuhiko Kajiyama, Utsunomiya-shi (JP)

(21) Appl. No.: 14/557,666

(22) Filed: Dec. 2, 2014

(30) Foreign Application Priority Data
Dec. 18, 2013 (JP) 2013-260791

(51) Int. Cl. G02B 21/14

(52) U.S. Cl. CPC G02B 21/14

(57) ABSTRACT

A phase difference observation apparatus includes an illumination optical system configured to introduce light from a light source onto an illumination surface, an opening unit provided inside the illumination optical system and including a plurality of openings, an imaging optical system configured to collect light from the illumination surface, and a complex amplitude modulation unit provided inside the imaging optical system and including a plurality of complex amplitude modulation regions, and the plurality of openings and the plurality of complex amplitude modulation regions radially extend around an optical axis of the illumination optical system or the imaging optical system.

### BACKGROUND OF THE INVENTION

1. Field of the Invention

The present invention relates to a phase difference observation apparatus.

2. Description of the Related Art

Previously, a phase difference microscope or a dark-field microscope has been used to observe a phase object (sample) that is represented as an unstained cell. In a typical phase difference microscope, an annular-shaped opening is formed in an illumination optical system, and a phase difference by λ/4 is given to direct light obtained after illuminating the sample by using a complex amplitude modulation region that is disposed inside an objective lens. As a result, a high contrast image can be obtained by interference of direct light and diffracted light. In this phase difference microscope, however, light which is called halo occurs at a boundary between a background and the sample when observing the sample which has a large amount of a phase difference. When the halo occurs, a detailed structure at the boundary between the background and the sample is buried in the halo and thus it is difficult to well observe the sample.

Japanese Patent Laid-open No. 2000-10013 discloses a phase difference microscope configured to decrease a width of the complex amplitude modulation region disposed inside an objective lens to achieve multiple annular complex amplitude modulation regions to reduce the influence of the halo. In this configuration, a ratio of both direct light and low-order diffracted light passing through the complex amplitude modulation region, which is a main factor of the halo, can be reduced.

Previously, a dark-field microscope that includes an illumination optical system having a large numerical aperture so that direct light from the illumination optical system is not incident on the objective lens to obtain an image only by diffracted light from a phase object has been known. However, the conventional dark-field microscope forms an image of the phase object only by using high-order diffracted light, and therefore an image in which a boundary of the phase object is only emphasized is formed. Accordingly, a quantitative observation cannot be performed although a qualitative observation is possible.

Japanese Patent Laid-open No. H09-189520 discloses a dark-field microscope configured to shield direct light from an illumination optical system by a plurality of small rectangular light shielding regions that are disposed inside an objective lens to contribute to formation of an image with respect to low-order diffracted light.

However, in the configuration of the phase difference microscope that is disclosed in Japanese Patent Laid-open No. 2000-10013, the plurality of complex amplitude modulation regions is provided in a radial direction around an optical axis of the objective lens and therefore the artifact easily occurs. Occurrence of the artifact causes a problem for observing an unstained cell.

In the configuration of the dark-field microscope that is disclosed in Japanese Patent Laid-open No. H09-189520, the light shielding region is very small, and therefore the influence of the manufacturing error or the adjustment error cannot be ignored and it is difficult to manufacture the microscope.

### SUMMARY OF THE INVENTION

The present invention provides a phase difference observation apparatus capable of observing quantitatively a phase difference with small artifact and capable of being manufactured easily.

A phase difference observation apparatus as one aspect of the present invention includes an illumination optical system configured to introduce light from a light source onto an illumination surface, an opening unit provided inside the illumination optical system and including a plurality of openings, an imaging optical system configured to collect light from the illumination surface, and a complex amplitude modulation unit provided inside the imaging optical system and including a plurality of complex amplitude modulation regions, and the plurality of openings and the plurality of complex amplitude modulation regions radially extend around an optical axis of the illumination optical system or the imaging optical system.

Further features and aspects of the present invention will become apparent from the following description of exemplary embodiments with reference to the attached drawings.

### BRIEF DESCRIPTION OF THE DRAWINGS

FIGS. 1A to 1C are a simulation result of a phase difference microscope as a comparative example.

FIGS. 2A to 2C are configuration diagrams of a phase difference observation apparatus in the embodiment.

FIGS. 3A and 3B are configuration diagrams of other complex amplitude modulation regions CAM and openings IA.

FIGS. 4A to 4C are a simulation result (comparative example) of a typical phase difference microscope.

FIGS. 5A to 5C are a simulation result of a phase difference observation apparatus in Embodiment 1.

FIGS. 6A to 6C are a simulation result of a phase difference observation apparatus in Embodiment 2.

FIGS. 7A to 7C are a simulation result (comparative example) of a typical dark-field microscope.

FIGS. 8A to 8C are a simulation result of a phase difference observation apparatus in Embodiment 3.

FIGS. 9A to 9C are a simulation result of a phase difference observation apparatus in Embodiment 4.

FIGS. 10A to 10C are a simulation result of the phase difference observation apparatus in Embodiment 4.

### DESCRIPTION OF THE EMBODIMENTS

Exemplary embodiments of the present invention will be described below with reference to the accompanied drawings.

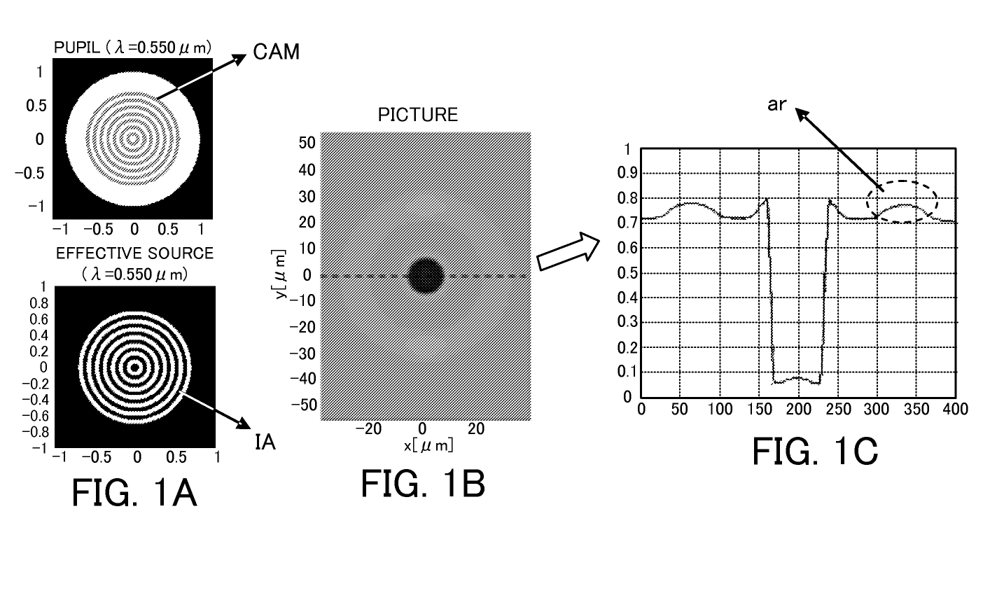

First of all, referring to FIGS. 1A to 1C, a phase difference observation apparatus (phase difference microscope) as a comparative example will be described. FIGS. 1A to 1C are a simulation result (comparative example) of the phase difference microscope. The simulation result of FIGS. 1A to 1C is a result that is obtained on the condition that a numerical aperture NA at a sample side of an objective lens is 0.2 and a wavelength λ is 0.55 μm. It is assumed that the sample is a cell having a diameter of around 20 μm and that a phase difference from a background is set to be λ/10. Complex amplitude modulation regions CAM modulate a phase by λ/4 and an intensity to 50%, respectively. The complex amplitude modulation regions CAM and openings IA of an illumination optical system have shapes similar to each other.

The upper side and the lower side of FIG. 1A illustrate multiple annular (zing zonal) complex amplitude modulation regions CAM and openings IA, respectively. FIG. 1B illustrates a two-dimensional image (object image) of the simulation. FIG. 1C is a cross-sectional view crossing the object image of FIG. 1B, and a vertical axis indicates the intensity of the image. As can be seen from FIG. 1C, the image contains an artifact ar, which may cause a problem for observing the unstained cell.

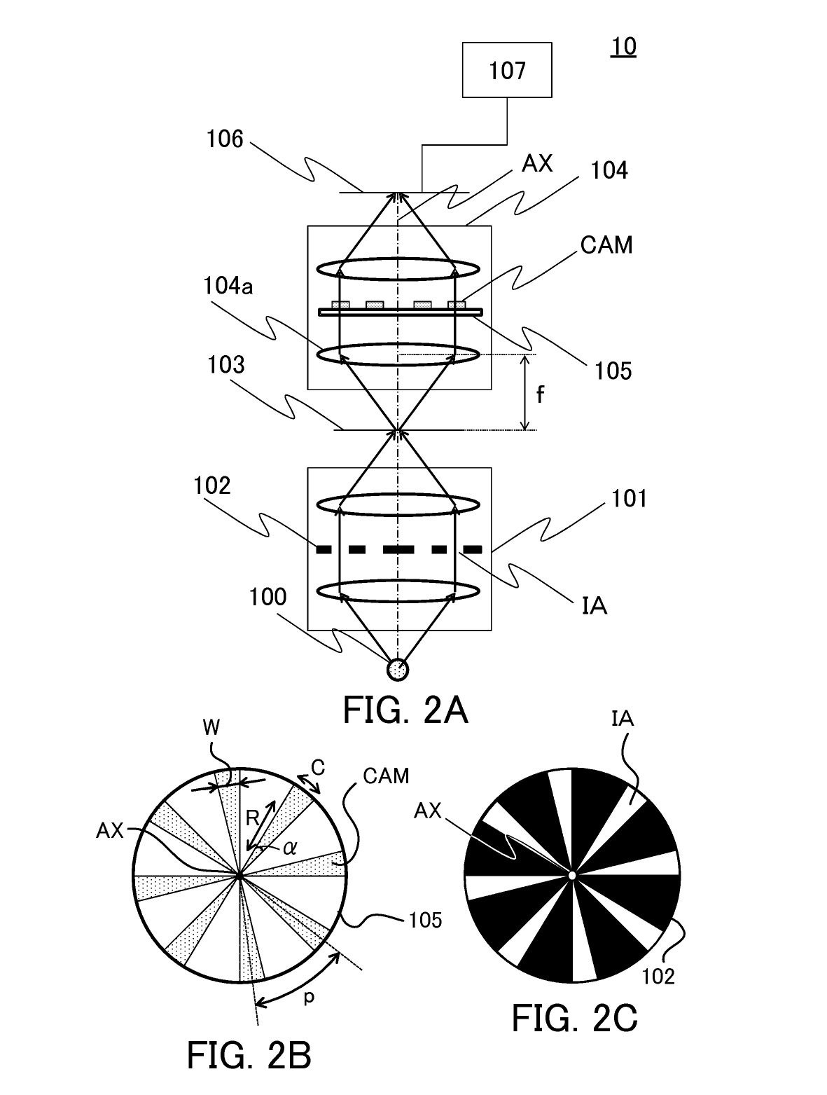

Subsequently, referring to FIGS. 2A to 2C, a phase difference observation apparatus (phase difference microscope) in the embodiment will be described. FIG. 2A is a configuration diagram of a phase difference observation apparatus 10.

Reference numeral 100 denotes a light source. Reference numeral 101 denotes an illumination optical system that introduces light emitted from the light source 100 onto an illumination surface (a sample 103). Reference numeral 102 denotes an aperture stop 102 (opening unit) that is provided inside the illumination optical system 101 and that has a plurality of openings IA. The plurality of openings IA formed on the aperture stop 102 limits the light emitted from the light source 100. As a result, the light emitted from the light source 100 is limited by the plurality of openings IA to illuminate the sample 103. In the embodiment, preferably, a variable aperture stop is used as the aperture stop 102. Using the variable aperture stop, a contrast or a resolution can be varied. As light that is used in the embodiment, visible light or near-infrared light (for example, a wavelength of 0.4 μm to 1.1 μm) is used.

Reference numeral 104 denotes an objective lens (imaging optical system) that collects the light from the illumination surface (sample 103). Reference numeral 105 denotes a complex amplitude modulation unit (light modulation unit) that is provided inside the objective lens 104 and that includes the plurality of complex amplitude modulation regions CAM (light modulation region). The plurality of complex amplitude modulation regions CAM are configure to modulate the phase or the intensity of direct light from the plurality of openings IA. The light from the illumination surface (sample 103) passes through the complex amplitude modulation unit 105 that is disposed inside the objective lens 104 to be imaged (collected) on an image pickup element 106. Data obtained from the image pickup element 106 are outputted to an image processing system 107. The image processing system 107 performs image processing on an output signal from the image pickup element 106 to generate image information.

FIGS. 2B and 2C are diagrams of the complex amplitude modulation regions CAM of the complex amplitude modulation unit 105 that are disposed inside the objective lens 104 and the openings IA that are provided inside the illumination optical system 101, respectively, when viewed in a direction of an optical axis AX. As illustrated in FIG. 2B, the complex amplitude modulation regions CAM have shapes of radially extending around the optical axis AX. Preferably, the complex amplitude modulation region CAM has a shape in which a length in a radial direction (direction of an arrow R) of a circle around the optical axis AX (circle in a plane orthogonal to the optical axis AX) is longer than a length in a circumferential direction (direction of an arrow C) of the circle. In the embodiment, for example, the complex amplitude modulation regions CAM have shapes (fan shapes) of radially extending at an angle α around the optical axis AX. Preferably, the plurality of complex amplitude modulation regions CAM and the plurality of openings IA are disposed at positions conjugate to each other, and they have shapes similar (or substantially similar) to each other. Preferably, considering a manufacturing error, the openings IA are set to be smaller than the shapes of the complex amplitude modulation regions CAM (or shapes similar to the shapes of the complex amplitude modulation regions CAM)

The complex amplitude modulation regions CAM of the complex amplitude modulation unit 105 are configured to modulate the phase or the intensity of the light from the illumination optical system 101. For example, the complex amplitude modulation regions CAM are configured by forming a film on a parallel plate or cutting the parallel plate to provide a phase difference of λ/4 or reduce the light or shield the light (or a combination of them).

In the embodiment, preferably, the complex amplitude modulation unit 105 is set to satisfy the following conditional expression (1) where an annular width Wn is defined as Wn=W/(NA×f).

Wn≦0.12×λ/NA (1)

In conditional expression (1), symbol W is a width (most off-axis width) of crossing the complex amplitude modulation region CAM in the circumferential direction of the circle around the optical axis AX. Symbol f is a total focal length of a lens 104a (lens total focal length) from the illumination surface (sample 103) to the complex amplitude modulation region CAM. Symbol λ (μm) is a maximum wavelength of the light from the light source 100, and symbol NA is a numerical aperture of the objective lens 104 at the side of the sample 103 (illumination surface side).

As illustrated in FIG. 2A, preferably, the following conditional expression (2) is satisfied where symbol p is an angle pitch of the complex amplitude modulation regions CAM that radially extend around the optical axis AX of the objective lens 104.

p≦60° (2)

The annular width Wn in conditional expression (1) is a width W that is standardized by a pupil diameter (NA×f) of the objective lens 104. A diffraction angle of an object by illumination light is defined as θ and is assumed to be determined by a first dark ring of an Airy disc. In the embodiment, an assumed diameter d of the object is 20 μm, and therefore the diffraction angle θ is represented by the following expression (3).

2 sin θ=2.44×λ/d≈0.12×λ (3)

In this case, the spread of diffracted light on a pupil plane of the objective lens 104 is represented by (2 sin θ×f). Therefore, the spread D of the diffracted light that is standardized by the pupil diameter (NA×f) of the objective lens 104 is represented by the following expression (4). A value represented by expression (4) corresponds to a right side of conditional expression (1).

D=(2 sin θ×f)/(NA×f)=0.12×λ/NA (4)

As described above, satisfying conditional expression (1), light intensities of both the direct light and low-order diffracted light passing through the complex amplitude modulation regions CAM can be reduced. Therefore, the halo or the artifact can be reduced. In addition, satisfying conditional expression (2), the number of the complex amplitude modulation regions CAM can be increased. Therefore, images that are formed by respective complex amplitude modulation regions CAM overlap with each other, and thus the artifact can be reduced.

Furthermore, it is preferable that the following conditional expression (1a) be satisfied.

Wn≦0.06×λ/NA (1a)

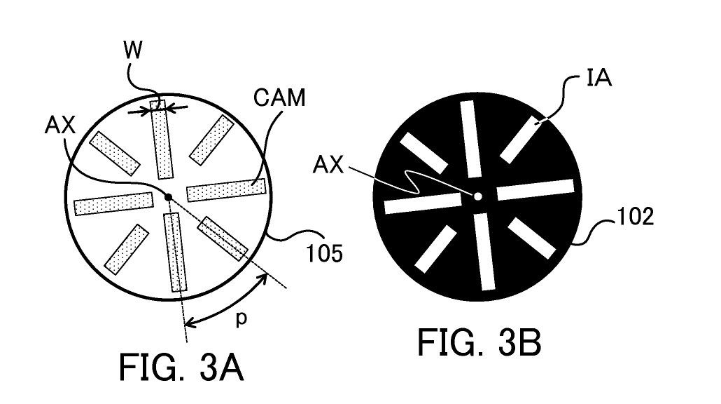

In the embodiment, as illustrated in FIGS. 2B and 2C, each of the complex amplitude modulation regions CAM and the openings IA has a fan shape that radially extends around the optical axis AX. The embodiment is not, however, limited to this. For example, as illustrated in FIGS. 3A and 3B, each of the complex amplitude modulation regions CAM and the openings IA may have a rectangular shape that radially extends around the optical axis AX. Alternatively, each of the complex amplitude modulation regions CAM or each of the openings IA may have different shape from each other. When the complex amplitude modulation regions CAM and the openings IA are arranged radially, it is not necessary to arrange them strictly centered around the optical axis AX. It is, however, preferable that they are arranged around neighborhood of the optical axis AX.

In the embodiment, satisfying conditional expression (1), the halo or the artifact can be reduced. In the embodiment, preferably, as illustrated in FIGS. 2A to 2C and FIGS. 3A and 3B, the plurality of complex amplitude modulation regions CAM and the plurality of openings IA are provided along a circumferential direction of the circle around the optical axis AX, instead of being provided along the radial direction of the circle. In this configuration, an image in which the halo and the artifact is further reduced can be obtained.

On the other hand, in the configuration disclosed in Japanese Patent Laid-open No. 2000-10013, a plurality of complex amplitude modulation regions are provided in a radial direction in a radial direction of a circle, and thus the artifact occurs in the radial direction of the circle and the artifact caused by a specific frequency component is emphasized as the plurality of complex amplitude modulation regions increase. On the other hand, in the embodiment, the plurality of complex amplitude modulation regions CAM are provided in the circumferential direction of the circle. Therefore, even when the artifact occurs in the circumferential direction of the circle, respective artifacts are superimposed while being shifted from each other as the plurality of complex amplitude modulation regions increase, and thus the artifact is not obscured.

### Embodiment 1

Embodiment 1 of the present invention will be described. A phase difference observation apparatus 10 of the embodiment is different from a typical phase difference observation apparatus or dark-field microscope in the configurations of a plurality of complex amplitude modulation regions CAM that are disposed inside an objective lens 104 and openings IA disposed inside an illumination optical system 101. Hereinafter, a simulation result with respect to an effect that is achieved by changing the configurations of the complex amplitude modulation regions CAM and the openings IA will be indicated. In the embodiment, the simulation is performed by using a single wavelength, and the wavelength λ is set to be 0.55 μm. It is assumed that a sample is a cell that has a diameter of around 20 μm, and a phase difference from a background is set to be λ/10.

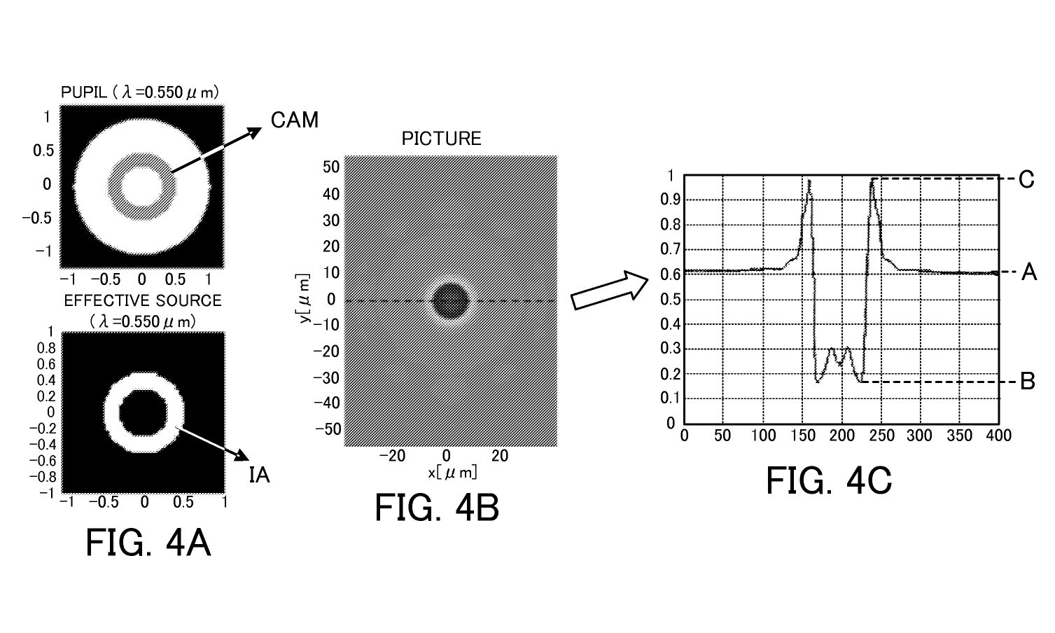

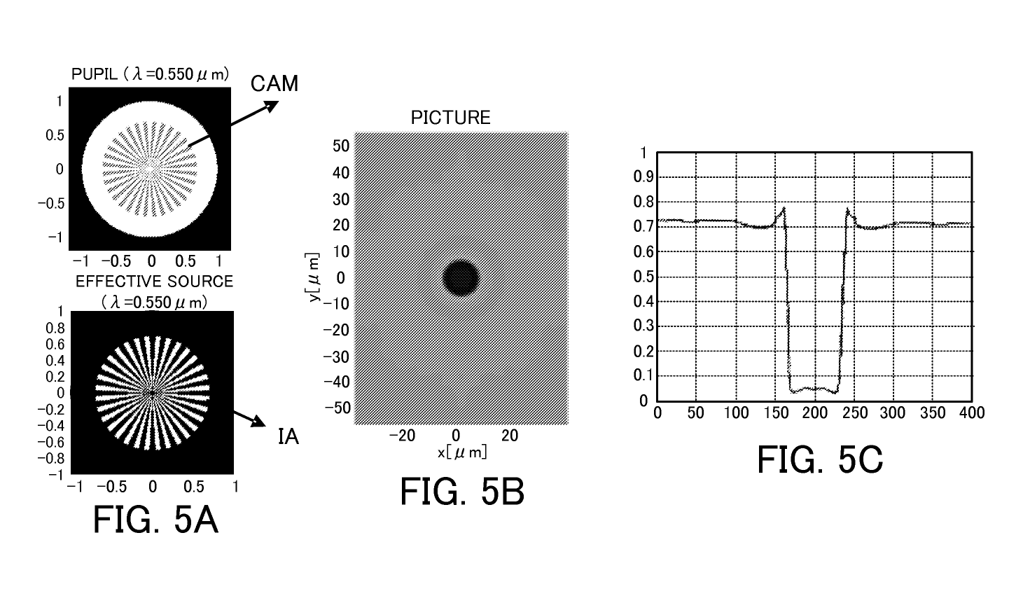

Subsequently, referring to FIGS. 4A to 4C and FIGS. 5A to 5C, using the simulation result obtained on the condition of NA=0.2, the phase difference observation apparatus of the embodiment will be described. The complex amplitude modulation regions CAM are configured to modulate a phase by λ/4 and an amplitude to 50%, respectively. The complex amplitude modulation regions CAM and the openings IA have similar shapes to each other.

FIGS. 4A to 4C are a simulation result of a typical phase difference microscope (a comparative example). The upper side and the lower side in FIG. 4A illustrate a complex amplitude modulation region CAM and an opening IA, respectively. FIG. 4B illustrates a simulated two-dimensional image (object image). FIG. 4C is a cross-sectional view of crossing the object image of FIG. 4B, and a vertical axis indicates an intensity of the image. The simulation result illustrated in FIGS. 4A to 4C is obtained on the condition that an annular width Wn of the complex amplitude modulation region CAM is 0.2.

An evaluation value Vh of the halo is defined as represented by the following expression (5) where A is the background intensity, B is the minimum intensity of the image, and C is the maximum intensity of the image in FIG. 4C.

Vh=(C−A)/(A−B) (5)

In the typical phase difference microscope, using expression (5), the evaluation value Vh of the halo is 0.84. In expression (5), (C−A) is the intensity of the halo and (A−B) is the intensity of the image. Accordingly, it is preferable that the evaluation value Vh of the halo is small.

FIGS. 5A to 5C are a simulation result of the phase difference observation apparatus in the embodiment. The upper side and the lower side in FIG. 5A illustrate the complex amplitude modulation regions CAM and the openings IA, respectively. FIG. 5B illustrates a simulated two-dimensional image (object image). FIG. 5C is a cross-sectional view of crossing the object image of FIG. 5B, and a vertical axis indicates an intensity of the image.

As illustrated in FIG. 5A, each of the complex amplitude modulation regions CAM is set to radially extend at an angle of 5 degrees (5°) around the optical axis AX and to have an angle pitch p (angle between adjacent complex amplitude modulation regions CAM) of 11.25 degrees. The annular width Wn of the complex amplitude modulation region is 0.061 at the most off-axis, and the right side in conditional expression (1) is 0.34. The evaluation value Vh of the halo is 0.08. According to the phase difference observation apparatus of the embodiment, the halo can be reduce compared to the typical phase difference microscope. In addition, the artifact does not occur.

### Embodiment 2

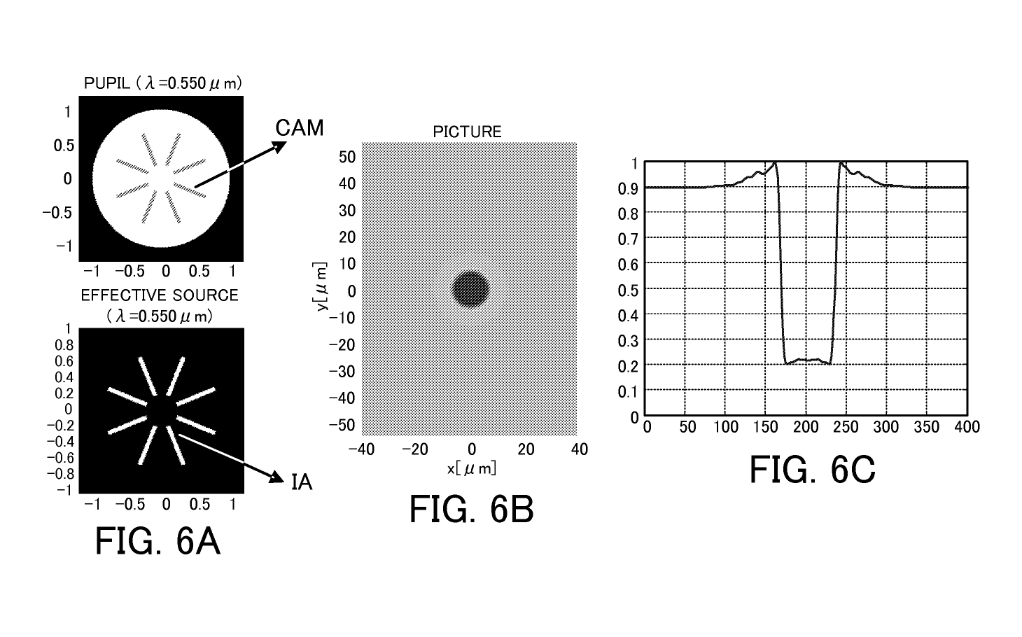

Next, referring to FIGS. 6A to 6C, Embodiment 2 of the present invention will be described. FIGS. 6A to 6C are a simulation result of a phase difference observation apparatus in the embodiment. The simulation result of FIGS. 6A to 6C is a result on the condition of NA=0.2, and the complex amplitude modulation regions CAM modulate only a phase by λ/4. Other configurations are the same as those of Embodiment 1.

The upper side and the lower side in FIG. 6A illustrate the complex amplitude modulation regions CAM and the openings IA, respectively. FIG. 6B illustrates a simulated two-dimensional image (object image). FIG. 6C is a cross-sectional view of crossing the object image of FIG. 6B, and a vertical axis indicates an intensity of the image.

As illustrated in FIG. 6A, each of the complex amplitude modulation regions CAM having a rectangular shape is set to radially extend around the optical axis AX and to have an angle pitch p (angle between adjacent complex amplitude modulation regions CAM) of 45 degrees. The annular width Wn of the complex amplitude modulation region is 0.05, and the right side in conditional expression (1) is 0.34. The evaluation value Vh of the halo is 0.27. According to the phase difference observation apparatus of the embodiment, the halo can be reduce compared to the typical phase difference microscope. In addition, the artifact does not occur.

### Embodiment 3

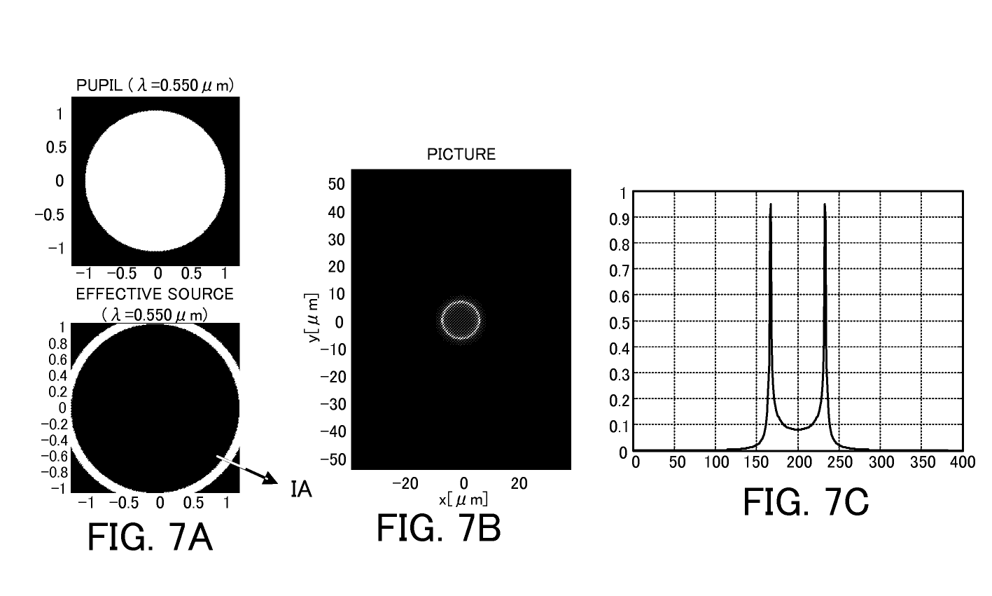

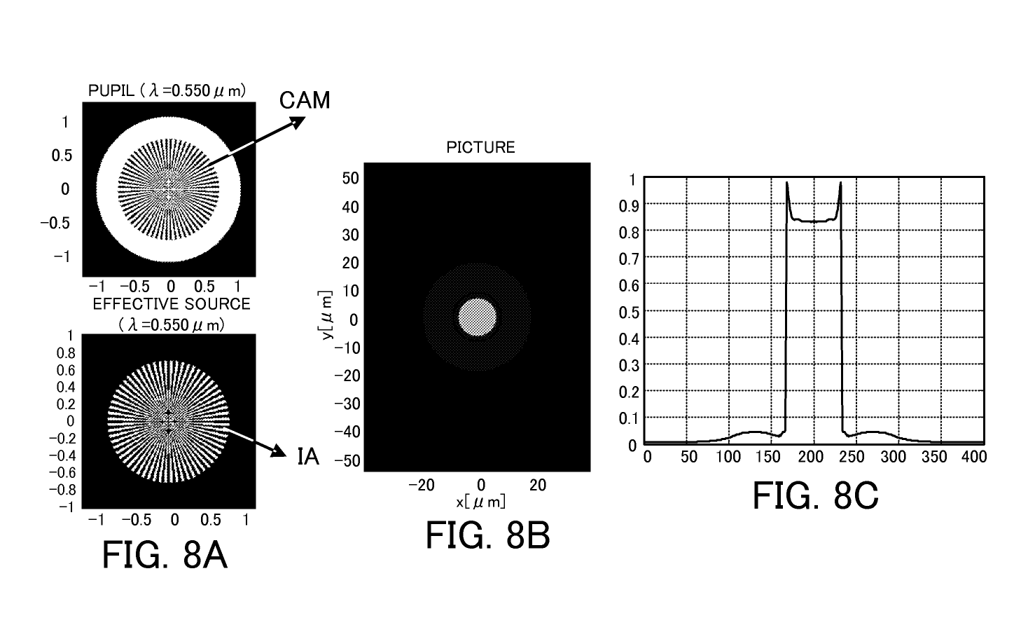

Next, referring to FIGS. 7A to 7C and FIGS. 8A to 8C, Embodiment 3 of the present invention will be described. The embodiment describes a simulation result of a phase difference observation apparatus on the condition of NA=0.7. Descriptions of the same configurations as those in Embodiment 1 will be omitted.

FIGS. 7A to 7C are a simulation result (comparative example) of a typical dark-field microscope. The upper side and the lower side in FIG. 7A illustrate a region corresponding to the complex amplitude modulation region CAM and an opening IA, respectively. FIG. 7B illustrates a simulated two-dimensional image (object image). FIG. 7C is a cross-sectional view of crossing the object image of FIG. 7B, and a vertical axis indicates an intensity of the image.

As can be seen from FIG. 7A, the typical dark-field microscope is not provided with the complex amplitude modulation region CAM, and performs illumination with a large numerical aperture so that light is not directly incident on an object lens. Furthermore, as can be seen from FIG. 7C, the typical dark-field microscope forms an image in which only a boundary of a sample is emphasized, and thus a qualitative observation can only be performed.

FIGS. 8A to 8C are a simulation result of the phase difference observation apparatus in the embodiment. The upper side and the lower side in FIG. 8A illustrate the complex amplitude modulation regions CAM and the openings IA, respectively. FIG. 8B illustrates a simulated two-dimensional image (object image). FIG. 8C is a cross-sectional view of crossing the object image of FIG. 8B, and a vertical axis indicates an intensity of the image.

As illustrated in FIG. 8A, each of the complex amplitude modulation regions CAM is set to radially extend at an angle of 2.5 degrees around the optical axis AX and to have an angle pitch p (angle between adjacent complex amplitude modulation regions CAM) of 5.625 degrees. The annular width Wn of the complex amplitude modulation region is 0.031 at the most off-axis, and the right side in conditional expression (1) is 0.096. The complex amplitude modulation regions CAM of the embodiment modulate only an amplitude to 0%, i.e. shield the light, and the complex amplitude modulation regions CAM and the openings IA have similar shapes to each other. As can be seen from FIG. 8C, according to the phase difference observation apparatus of the embodiment, the intensity of the image exists at the center of a sample and a quantitative visualization can be achieved compared to the typical dark-field microscope.

### Embodiment 4

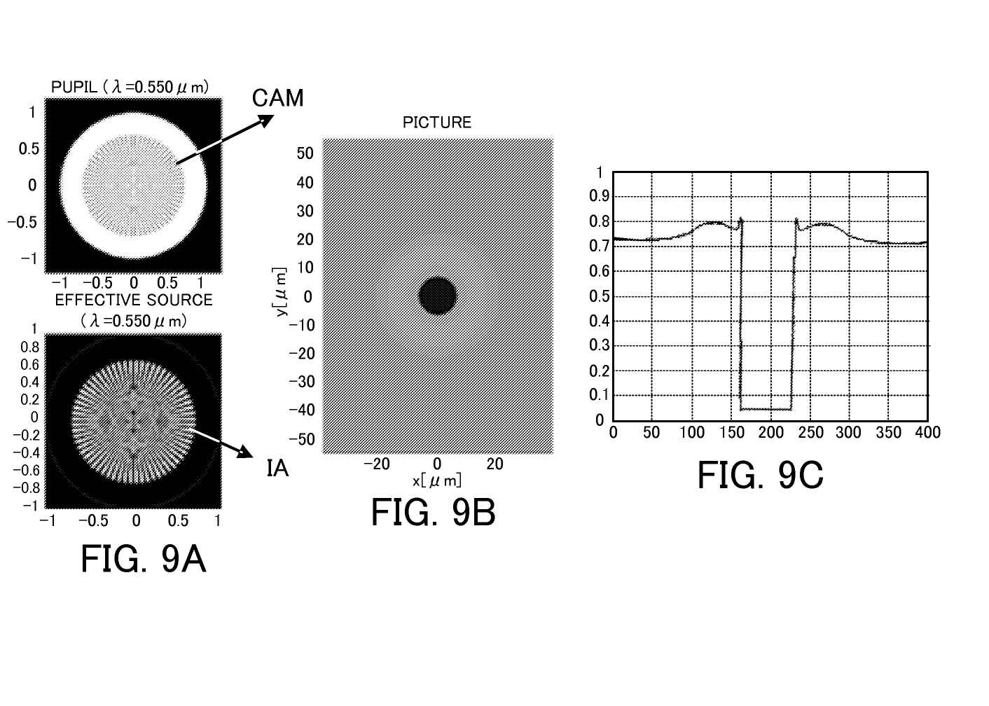

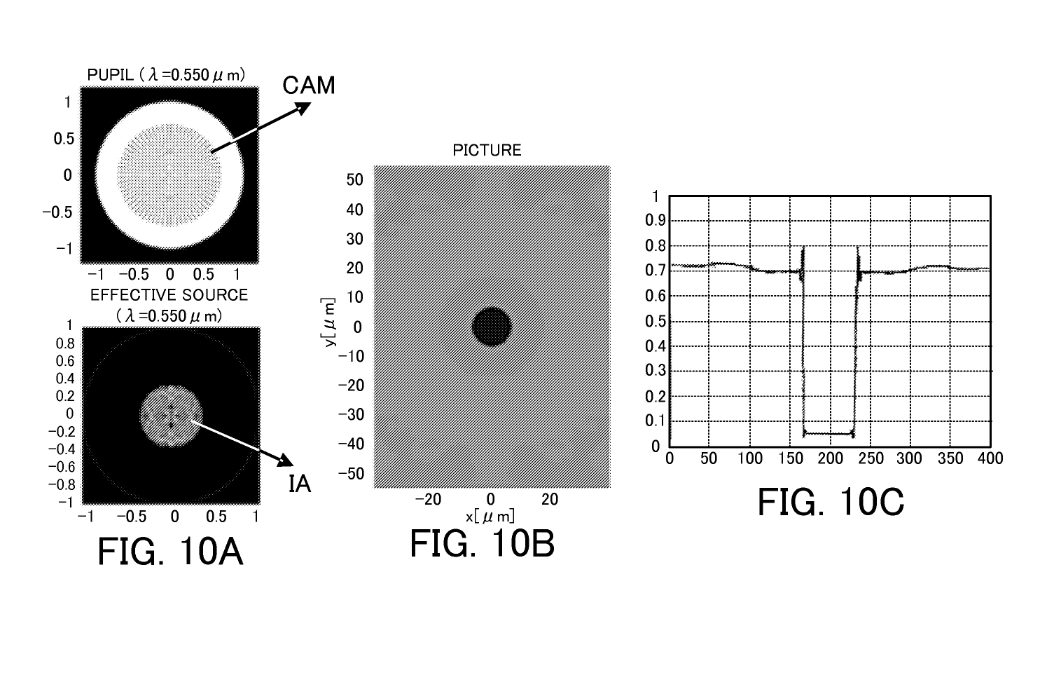

Next, referring to FIGS. 9A to 9C and FIGS. 10A to 10C, Embodiment 4 of the present invention will be described. The embodiment describes simulation results of a phase difference observation apparatus on the condition of NA=0.7. FIGS. 9A to 9C and FIGS. 10A to 10C illustrate simulation results of the phase difference observation apparatus in the embodiment. FIGS. 10A to 10C illustrate the simulation result of the opening IA in which the aperture stop 102 is closed by half with respect to the simulation condition of FIGS. 9A to 9C. In the embodiment, descriptions of the same configurations as those in Embodiment 1 will be omitted.

The upper side and the lower side in each of FIGS. 9A and 10A illustrate the complex amplitude modulation regions CAM and the openings IA, respectively. FIGS. 9B and 10B illustrate simulated two-dimensional images (object images). FIGS. 9C and 10C are cross-sectional views of crossing the object images of FIGS. 9B and 10B, respectively, and vertical axes indicate intensities of the images.

As illustrated in FIG. 9A, each of the complex amplitude modulation regions CAM is set to radially extend at an angle of 2.5 degrees around the optical axis AX and to have an angle pitch p (angle between adjacent complex amplitude modulation regions CAM) of 5.625 degrees. The annular width Wn of the complex amplitude modulation region is 0.031 at the most off-axis, and the right side in conditional expression (1) is 0.096. The evaluation value Vh of the halo is 0.13 and thus the phase difference observation apparatus of the embodiment can significantly reduce the halo compared to a typical phase difference phase microscope.

As illustrated in FIGS. 10A and 10C, even in the state of the opening IA where the aperture stop 102 is closed by half, the imaging can be achieved while the halo is reduced. On the other hand, a typical phase difference microscope uses an annular illumination, and thus the opening of an illumination optical system cannot be closed and the contrast or the resolution cannot be adjusted.

In each embodiment, the plurality of openings IA and the plurality of complex amplitude modulation regions CAM extend radially around the optical axis AX of the illumination optical system 101 or the objective lens 104. Preferably, the plurality of openings IA and the plurality of complex amplitude modulation regions CAM have similar shapes to each other. Preferably, each of the plurality of openings IA and the plurality of complex amplitude modulation regions CAM has a shape in which a length in a radial direction of a circle around the optical axis AX is longer than a length in a circumferential direction of the circle. Preferably, each of the plurality of openings IA and the plurality of complex amplitude modulation regions CAM has a fan shape or a rectangular shape.

According to each embodiment, a phase difference observation apparatus capable of quantitatively observing (visualizing) a phase difference with small artifact and capable of being manufactured easily can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. For example, each embodiment describes the configuration in which an image is formed on the image pickup element, and alternatively the image may be observed by eye using an eyepiece lens. Each embodiment describes the configuration of using the transmissive illumination, and alternatively epi-illumination may be used.

This application claims the benefit of Japanese Patent Application No. 2013-260791, filed on Dec. 18, 2013, which is hereby incorporated by reference herein in its entirety.

What is claimed is:

1. A phase difference observation apparatus comprising:
an illumination optical system configured to introduce light from a light source onto an illumination surface;
an opening unit provided inside the illumination optical system and including a plurality of openings;
an imaging optical system configured to collect light from the illumination surface; and
a complex amplitude modulation unit provided inside the imaging optical system and including a plurality of complex amplitude modulation regions,
wherein the plurality of openings and the plurality of complex amplitude modulation regions radially extend around an optical axis of the illumination optical system or the imaging optical system.

2. The phase difference observation apparatus according to claim 1,
wherein the plurality of complex amplitude modulation regions are configured to modulate a phase or an intensity of direct light from the plurality of openings.

3. The phase difference observation apparatus according to claim 1,
wherein the plurality of complex amplitude modulation regions are provided at positions conjugate to the plurality of openings.

4. The phase difference observation apparatus according to claim 1,
wherein the plurality of openings and the plurality of complex amplitude modulation regions have shapes similar to each other.

5. The phase difference observation apparatus according to claim 1,
wherein each of the plurality of openings and the plurality of complex amplitude modulation regions has a shape in which a length in a radial direction of a circle around the optical axis is longer than a length in a circumferential direction of the circle.

6. The phase difference observation apparatus according to claim 1,
wherein each of the plurality of openings and the plurality of complex amplitude modulation regions has a fan shape.

7. The phase difference observation apparatus according to claim 1,
wherein each of the plurality of openings and the plurality of complex amplitude modulation regions has a rectangular shape.

8. The phase difference observation apparatus according to claim 1,
wherein the following conditional expression is satisfied:
Wn≦0.12×λ/NA
where W is a width of crossing the complex amplitude modulation region in a circumferential direction of a circle around the optical axis, f is a total focal length from the illumination surface to the complex amplitude modulation region, λ (μm) is a maximum wavelength of the light source, NA is a numerical aperture of the imaging optical system at an illumination surface side, and Wn is defined as Wn=W/(NA×f).

9. The phase difference observation apparatus according to claim 1,
wherein the following conditional expression is satisfied:
p≦60°
where p is a pitch of an angle of the plurality of complex amplitude modulation regions around the optical axis.

10. The phase difference observation apparatus according to claim 1,
wherein the opening unit is a variable aperture stop in which the plurality of openings are formed.

11. The phase difference observation apparatus according to claim 1,
wherein the imaging optical system includes an objective lens.

12. The phase difference observation apparatus according to claim 1,
wherein the plurality of openings are smaller than the plurality of complex amplitude modulation regions.
